(19) United States
(12) Patent Application Publication
(10) Pub. No.: US 2008/0165001 A1
(43) Pub. Date: Jul. 10, 2008

(54) Methods and apparatuses for false alarm elimination

(76) Inventors: David A. Drake, Escondido, CA (US); Gregory M. Quist, Escondido, CA (US)

Correspondence Address: NATH & ASSOCIATES, 112 South West Street, Alexandria, VA, 22314, US

(21) Appl. No.: 12/003,717

(22) Filed: Dec. 31, 2007

Related U.S. Application Data
(60) Provisional application No. 60/879,061, filed on Jan. 8, 2007.

(51) Int. Cl. G08B 13/00

(52) U.S. Cl. 340/550

(57) ABSTRACT

A method for determining false alarms at an entry to an enclosure includes: receiving a first reading from a first sensor representing intrusion of the enclosure, receiving a second reading from a second sensor, and generating an entry alarm if the second reading confirms intrusion of the enclosure. An apparatus that determines false alarms at an entry to an enclosure includes a first sensor which senses for intrusion of the enclosure, a second sensor, and a processor with instructions for generating an alarm if the first sensor detects intrusion of the enclosure and the second reading confirms intrusion of the enclosure. Another method for determining false alarms includes receiving readings from a sensor over a period of time, storing the readings at least temporarily in a memory, and comparing a window of the stored readings to a stored signature. An entry alarm is generated based on a comparison of the stored readings to the stored signature.

### CROSS-REFERENCE TO RELATED APPLICATIONS

This application claims the benefit of U.S. Provisional Patent Application No. 60/879,061, filed Jan. 8, 2007, the contents of which are hereby incorporated by reference in their entirety.

### BACKGROUND OF THE INVENTION

1. Field of the Invention

The present disclosure relates to methods and apparatuses for false alarm elimination, and in particular, to methods and apparatuses for eliminating false alarms when monitoring for intrusion at an enclosure such as a manhole.

2. Related Art

Various types of mechanical and electro-mechanical devices can be used to detect the opening of doors, hatches, windows, or other entries into enclosures. Examples of these types of devices include tilt switches (see, for example, the Slope Alert™ Tilt Warning System by Rieker Inc. of Folcraft, Pa.), accelerometers (see, for example, the MA11 by Honeywell Sensotec of Columbus, Ohio), and magnetic contacts (see, for example, the AMS-38B by Amseco, St. Louis, Mo.), among others.

However, the use of acceleration, tilt, contact or other electro-mechanical or opto-mechanical sensors to detect the opening of doors or hatches has a fundamental drawback of false alarms, which may be caused by external vibration of the device and/or a short duration acceleration that is in fact unrelated to actual opening of the door or hatch. Examples of these false alarms can include, but are not limited to, the setting off of car alarms due to thunder; house alarms being triggered by earthquakes or sonic booms; and hatch contacts being triggered by vibration from vehicles moving near or on the hatch.

### SUMMARY OF THE INVENTION

The present subject matter addresses the above concerns by teaching the following methods and apparatuses.

The present disclosure includes a method for determining false alarms at an entry to an enclosure. The method includes the steps of receiving a first reading from a first sensor representing intrusion of the enclosure; receiving a second reading from a second sensor; and generating an entry alarm if the second reading confirms intrusion of the enclosure.

In some aspects, the method includes the step of suppressing generation of the entry alarm if the second reading does not confirm intrusion of the enclosure.

In some aspects, the method includes the step of receiving multiple readings from a plurality of sensors, and combining the multiple readings to produce the first reading or the second reading.

In some aspects, the method includes the step of providing the first sensor or the second sensor with a tolerance such that the corresponding reading is provided only when the tolerance is exceeded.

In some aspects, the generating step includes transmitting alarm information to a central server.

The present disclosure also includes an apparatus that determines false alarms at an entry to an enclosure. The apparatus includes a first sensor which senses for intrusion of the enclosure and generates a first reading, a second sensor that generates a second reading, and a processor comprising instructions for generating an alarm if the first sensor detects intrusion of the enclosure and the second reading confirms intrusion of the enclosure.

In some aspects, the first sensor is a tilt sensor attached to a cover of the enclosure, and the first reading corresponds to tilting of the cover. In some aspects, the first sensor is an acceleration sensor attached to a cover of the enclosure, and the first reading corresponds to acceleration of the cover.

In some aspects, the second sensor is a ranging sensor attached to a cover of the enclosure, and the second reading corresponds to a distance from an opposing boundary of the enclosure. In some aspects, the second sensor is an ultrasonic or laser ranger.

In some aspects, the first sensor is a tilt sensor, an acceleration sensor, a position sensor, a magnetic contact, a physical contact switch, an optical monitor, a ranging sensor, or a level sensor, and the second sensor is a tilt sensor, an acceleration sensor, a position sensor, a magnetic contact, a physical contact switch, an optical monitor, a ranging sensor, or a level sensor.

In some aspects, the apparatus includes a two-way communication module connected to the processor for communicating the alarm.

In some aspects, the enclosure is a manhole, and the first sensor, the second sensor, or both are attached to a cover of the manhole. In some aspects, the enclosure is a room, and the first sensor, the second sensor, or both are attached to a door or window of the room.

The present disclosure also includes another method for determining false alarms at an entry to an enclosure. The method includes the steps of receiving readings from a sensor over a period of time, storing the readings at least temporarily in a memory, and comparing a window of the stored readings to a stored signature. The window spans a preselected period of time. The stored signature represents a corresponding period of time. In one aspect, the stored signature represents intrusion of the enclosure, and an entry alarm is generated if the stored readings match the stored signature. In another aspect, the stored signature represents no intrusion of the enclosure, and an entry alarm is generated if the stored readings do not match the stored signature.

Optionally, an entry alarm is suppressed based on comparison of the reading to the signature.

In some aspects, the sensor is a tilt sensor, an acceleration sensor, a position sensor, a magnetic contact, a physical contact switch, an optical monitor, a ranging sensor, or a level sensor.

In some aspects, the stored signature and stored reading are digitally stored, and the stored reading is digitally compared to the stored signature.

In some aspects, the generating step comprises transmitting alarm information to a central server.

In some aspects, the enclosure is a manhole, and the sensor is an acceleration or tilt sensor attached to a cover of the manhole. In some aspects, the enclosure is a room, and the sensor is an acceleration sensor or contact switch attached to a door or window of the room.

### BRIEF DESCRIPTION OF THE DRAWINGS

The features, nature, and advantages of the presently disclosed methods and apparatuses will become more apparent from the detailed description set forth below when taken in conjunction with the drawings in which like reference characters identify corresponding items throughout.

FIG. 1 charts a method for determining false alarms at an entry to an enclosure.

FIG. 2 shows an embodiment for an apparatus that determines false alarms at an entry to an enclosure, where the entry is in a closed state.

FIG. 3 shows the embodiment of FIG. 2, where the entry is in an open state.

FIG. 4 shows a schematic internal diagram of an apparatus that determines false alarms at an entry to an enclosure.

FIG. 5a charts a further method for determining false alarms at an entry to an enclosure.

FIG. 5b charts a still further method for determining false alarms at an entry to an enclosure.

FIG. 6 shows a window of time with a false alarm sensor reading overlaid on a stored signature representing intrusion of an enclosure, according to the method of FIG. 5a.

FIG. 7 shows a window of time with a true alarm sensor reading overlaid on a stored signature representing intrusion of an enclosure, according to the method of FIG. 5a.

### DETAILED DESCRIPTION

In the following detailed description, reference is made to the accompanying drawings, which form a part hereof, and in which are shown by way of illustration specific embodiments in which the subject matter may be practiced. In this regard, terminology such as “first,” “then,” “afterwards,” “before,” “next,” “finally,” “above,” “below,” “top,” “bottom,” “front,” “back,” “leading,” “trailing,” etc., is used with reference to the drawing being described. Because the processes and methods of the present subject matter can be performed in a number of different orders, and because the individual elements of the apparatus and systems of the present subject matter may be configured in a number of different orders, the above terminology is used for purposes of illustration and is in no way limiting. It is to be understood that other embodiments may be utilized and logical changes may be made without departing from the scope of the present subject matter. The following detailed description, therefore, is not to be taken in a limiting sense, and the scope of the present subject matter includes the full scope of the appended claims.

Although a number of discrete embodiments are described below, it is to be understood that these are merely non-limiting examples, and that any given embodiment of the subject matter may comprise some of the features of one shown embodiment, and/or some of the features of another shown embodiment. In the charts presented herewith, optional steps are illustrated in dashed lines. Other modifications between embodiments will be clear to one skilled in the art upon reading the following disclosure.

The present disclosure provides methods and apparatuses to solve the problem of unwanted or false alarms from standard alarm systems. In one aspect, readings from two or more sensors are analyzed to detect of the opening of an entry into an enclosure. In another aspect, readings from a sensor are checked against a stored signature before any alarm is generated.

According to one aspect of the present disclosure, although this does not limit the disclosure in any way, false alarms are eliminated from mechanical sensors such as tilt switches or accelerometers mounted on or near manhole covers that are triggered by accelerations or vibrations from a variety of sources, including but not limited to traffic, sonic booms, earthquakes or other phenomena that are not related to the opening of the manhole itself. The elimination of false alarms is achieved by combining the readings of another sensor, for example, an acoustic sensor that senses range, with the original electromechanical sensor such as a tilt sensor. The conditions that create false alarms, such as rotation of the manhole cover or the vibration of the manhole cover are checked against the reading of the secondary sensor, which may be present in the manhole for other reasons, such as measuring water level in the manhole, and which generally will not be affected by such mechanical disturbances. If both sensors fail to produce coincident readings that indicate an entry, such as a tilt/acceleration reading from the tilt/acceleration sensor and a change in level that would be due to the manhole cover being lifted, then no entry alarm will be dispatched.

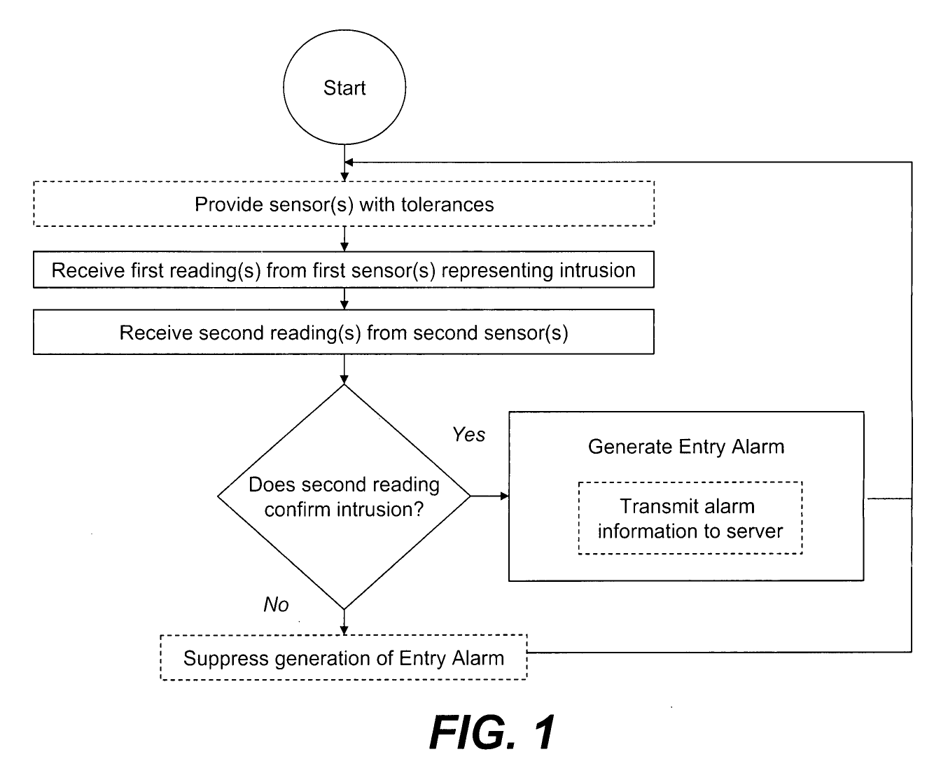

FIG. 1 charts a method for determining false alarms at an entry to an enclosure as discussed above.

The method begins by receiving readings from sensors. As shown, a first reading is received from a first sensor, and a second reading is received from a second sensor. Although shown linearly, it should be noted that these readings may be received simultaneously, or in a different order. In addition, although the method involves steps taken when the first sensor receives a reading representing intrusion of an enclosure, the sensors may periodically or continuously return readings until., during, and after any intrusion type event.

The first or second sensors may optionally be provided with tolerances, such that readings below a certain tolerance are suppressed, and readings are provided only when the tolerance is exceeded. Alternatively, the sensors may provide readings at any time or in any sequence, where these readings are logged, but may only be acted upon when they exceed a certain threshold, or match a certain signature, as detailed below.

In any case, once a first reading is received from a first sensor representing intrusion of the enclosure, a second reading is received from a second sensor and the second reading is reviewed by comparison to a signature, or to a threshold value, or any other type of reading or analysis suitable for the type of sensor. If the second reading confirms intrusion of the enclosure, an alarm is generated. The alarm may be an event which occurs at the enclosure, such as an audible alarm, or the logging of the time and circumstances of the intrusion in a memory for later transmission. Alternatively or additionally, the alarm may be in the form of a transmission to a central server from which further action may be taken.

Optionally, if the second reading does not confirm intrusion of the enclosure, one or more actions which would otherwise occur may be suppressed. As a non-limiting example, generation of an entry alarm which would otherwise occur when a first reading is made may be suppressed because the second reading does not confirm intrusion.

Although the term “sensor” is used herein, it should be noted that the present disclosure is not limited to merely two sensors. Multiple readings may be received from a plurality of sensors and combined to produce a single reading, which may serve as the first reading or the second reading. Also, any number of first or second sensors may be used, where any single reading from any one of these sensors may be used alone as the first reading or the second reading. As a non-limiting example, if four sensors (labeled A, B, C, and D) are used, sensors A and B may each measure intrusion of an enclosure by the same or different methods, while sensors C and D may each measure water depth by the same or different methods. In this example, the “first reading” may be whether either of sensor A or sensor B register an intrusion, while the “second reading” may be the average of the readings from sensor C and sensor D. Thus, any reading from sensor A or sensor B will signify intrusion of the enclosure, but an alarm will be generated only if the average reading of sensors C and D confirms intrusion, thereby further preventing a false alarm from the reading of only sensor C or sensor D alone.

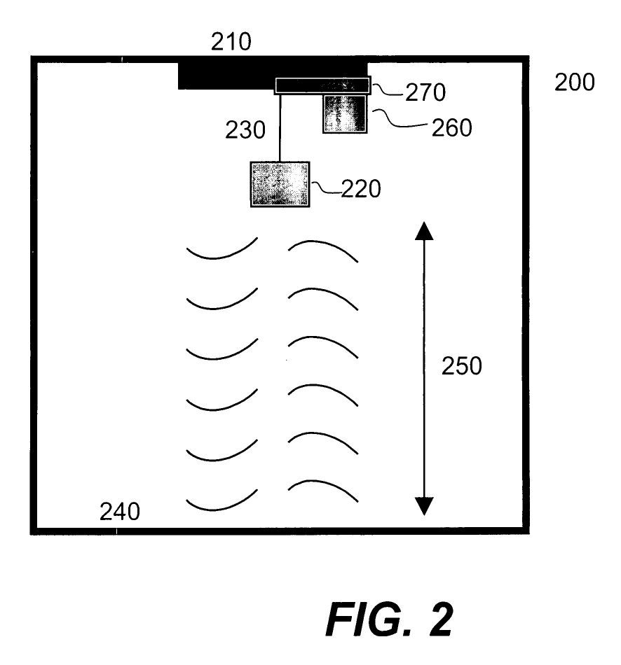

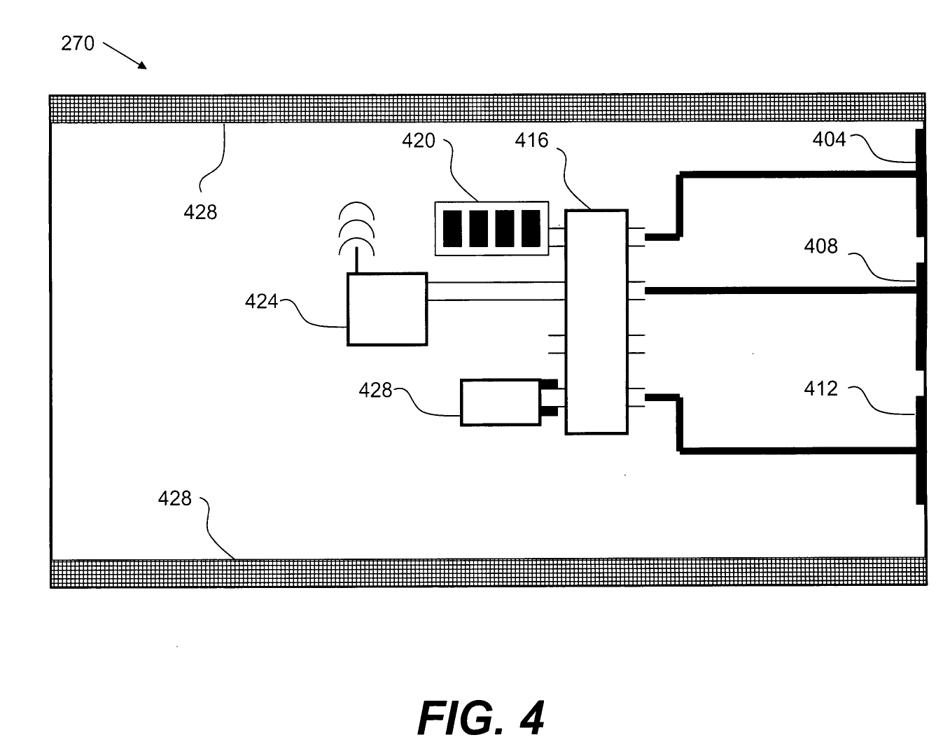

Operation of an apparatus that determines false alarms at an entry to an enclosure will now be described with reference to FIG. 2. The apparatus is optionally disposed at a manhole cover 210 to a manhole 200, but may equally be disposed at any other enclosure, including (without limitation) a room, where one or more sensors are attached to a door or window of the room. The apparatus includes a first sensor 260 which senses for intrusion of the enclosure, a second sensor 220, and a processor (inside housing 270, which will be described in greater detail with reference to FIG. 4 below) comprising instructions for generating an alarm if the first sensor detects intrusion of the enclosure and the second reading confirms intrusion of the enclosure.

As shown, the first sensor 260 is a tilt sensor attached to the manhole cover 210, and readings from this first sensor correspond to tilting of the cover 210. Alternatively, however, and without limitation, the first sensor may be an acceleration sensor attached to a cover of the enclosure, where the first reading corresponds to acceleration of the cover, or the first sensor may be a position sensor, a magnetic contact, a physical contact switch, an optical monitor, a ranging sensor, or a level sensor.

The use of a tilt sensor 260, or any single sensor, can lead to false alarms. For example, if the manhole cover 210 is jostled in place or rotated due to traffic or some other means, the acceleration/tilt sensor 260 attached to the cover could register an alarm without actually being tilted during opening. Accordingly, a second sensor 220 is used to confirm whether opening/intrusion has occurred.

As shown in this embodiment, the second sensor 220 is an ultrasonic ranging sensor suspended by a cable 230 from the manhole cover 210, and the second reading, made by transmitting a sound and timing its return, corresponds to a distance 250 from an opposing boundary 240 of the enclosure. Although shown here as a rigid boundary 240, the opposing boundary 240 may as a non-limiting example be measured at the water level inside the enclosure. Alternatively, however, and without limitation, the second sensor may be a laser ranger, and the second reading may be made by transmitting a light beam and timing its return through interferometry or other measurements, or the second sensor may be a tilt sensor, an acceleration sensor, a position sensor, a magnetic contact, a physical contact switch, an optical monitor, or a level sensor.

As in FIG. 2, if the cover 210 has not actually been moved, then even if the first sensor 260 registers tilt/acceleration, etc., the measured distance 250 will remain within a given tolerance of the normal distance measurement with the cover in normal closed position, and no alarm will be generated (or alternatively, alarm activity may be suppressed).

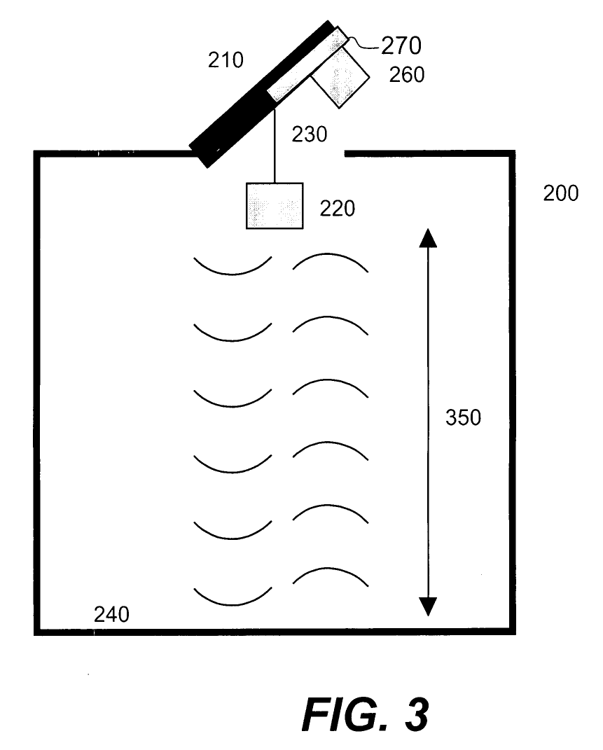

However, as shown in FIG. 3, when the manhole 200, which was closed in FIG. 2, is now open, the manhole cover 210 is tilted. Consequently, the sensor 260 is tilted, and sends a reading corresponding to intrusion of the manhole. The second sensor 220 also provides a distance 350 which differs from the previous distance 250, in that a longer distance is measured, suggesting that the manhole cover has been lifted, which also corresponds to intrusion of the manhole. Because the processor disposed in housing 270 identifies that both readings correspond to intrusion, an alarm is generated.

The combination of sensors for generating an alarm for a cover may be shown with the following table:

| Acceleration/ | | |
|---|---|---|
| Tilt Sensor | Distance Sensor | Result |
| ALARM | NO CHANGE | NO INTRUSION ALARM |
| ALARM | DISTANCE CHANGED | INTRUSION ALARM |
| NO ALARM | NO CHANGE | NO INTRUSION ALARM |
| NO ALARM | DISTANCE CHANGED | NO INTRUSION ALARM |

One of skill in the art will recognize that any number of sensors may be used as the first sensor, but more significantly, also as the second confirmatory sensor. As a non-limiting example, the first sensor may be a tilt sensor specifically installed for sensing intrusion, while the second sensor may sense an environmental parameter generally, but in a manner which may used on occasion to confirm intrusion readings. One or both sensors may sample or monitor (as non-limiting examples) humidity, moisture, temperature, gas content, water level, water quality, flow rates, vibration, acoustic levels and content, optical levels and content, opening or closing of the enclosure cover, power current flow, power voltage, telecommunications measurements, natural gas pressure, natural gas flow, petrochemical pressure, petrochemical flow, and/or security measurements. The sensors may perform (as non-limiting examples) fire detection, chemical detection, biological detection, fluid level detection, fluid flow detection, or other hazard detections. Any of these detections may creatively be used to detect or confirm intrusion.

FIG. 4 shows a detail of housing 270, showing the internal equipment which allows the apparatus to perform the initial and confirmatory measurements, which will now be described. In FIG. 4, housing 270 comprises an attachment area 432, with which the housing may be attached to the underside of a manhole cover or to the interior of a manhole, or to the opening of an enclosure or the enclosure more generally. This attachment area may be, but is not limited to, a riveting or bolting area, an adhesive area, a magnetic attachment mechanism, or any other attachment mechanism. Attachment mechanisms can include glue, threaded bolts, rivets, metal screws, tape, epoxy, staples, nails, adhesive strips, or magnets. As a non-limiting example, the housing 270 may be attached to the cover, door, window, or other portion of an enclosure or its opening, by neodymium magnets. The attachment mechanism may lend itself to repositioning, or may be attached so as to be difficult to reposition once a position has been selected.

The housing includes a power source 428. The power source 428 may be, as non-limiting examples, a battery, fuel cell, or any other appropriate generator or repository of energy. The power source 428 may be entirely self contained, and may be rechargeable or replaceable. Alternatively, the power source 428 may instead derive its power from outside of the enclosure (as non-limiting examples, from a connection to an external power source on the power grid or from solar panels), or may derive its power from inside of the enclosure (as non-limiting examples, from a connection to an external power source on the grid or from hydroelectric power derived from fluid flow within the enclosure or any other source of renewable energy available at or in the enclosure).

The housing 270 also includes port 404 to which a first sensor may be attached or hardwired, and port 408 to which a second sensor may be attached or hardwired. As noted above, the present disclosure is not limited to the use of two sensors, so a third port 412 is also shown, while any number of ports may be used.

A processor 416 receives and compares the readings received at ports 404, 408, and optionally 412. Although shown as one element here, the processor 416 may include one or more of the following, as non-limiting examples: a printed circuit (PC) board computer, an analog to digital converter, a logic circuit, memory for storing measurements or samples, or other electronic components. Readings may optionally be stored in a memory 420.

When an alarm is to be generated, communication module 424 (which may be a pager or other radio transmission device, or a two-way communication module, or any other communication device), may be used to transmit the alarm to a central server. The communication module 424 may, as a non-limiting example, be a wireless transmitter, or may communicate via wires. The communication device 424 may communicate via any number of known protocols, including, as non-limiting examples, Ethernet, CDMA, GSM, TDMA, Bluetooth, 802.11b, 802.11g, 802.11n, WiFi, EVDO, WiFiMAX, Reflex25, Reflex50, ZigBee, RFID, an analog modem connection, or any other protocol. The communication device 424 may be configured to communicate with another communication device outside of the housing 270. In this way, the communication device 424 may relay measurements from within the enclosure to those outside of the enclosure. The communication device 424 may send signals periodically, at the occurrence of an event generating an alarm, or both.

In a second aspect of the present disclosure, false alarms are eliminated not by multiple sensors, but by comparing a window of readings from a single sensor to a stored signature. An “entry signature” of acceleration or tilt readings, such as would be created by a real entry through a door or hatch such as a manhole cover, is distinguished from a “non-entry signature.” As a non-limiting example, this distinguishing may be made based upon the time response of the entry alarms, where an alarm is dispatched only if the entry signature is sufficiently different from the non-entry signature. The amount of difference between the two time responses is dependent upon the circumstances that generate the responses and may be selected to minimize false alarms or minimize missing actual entries.

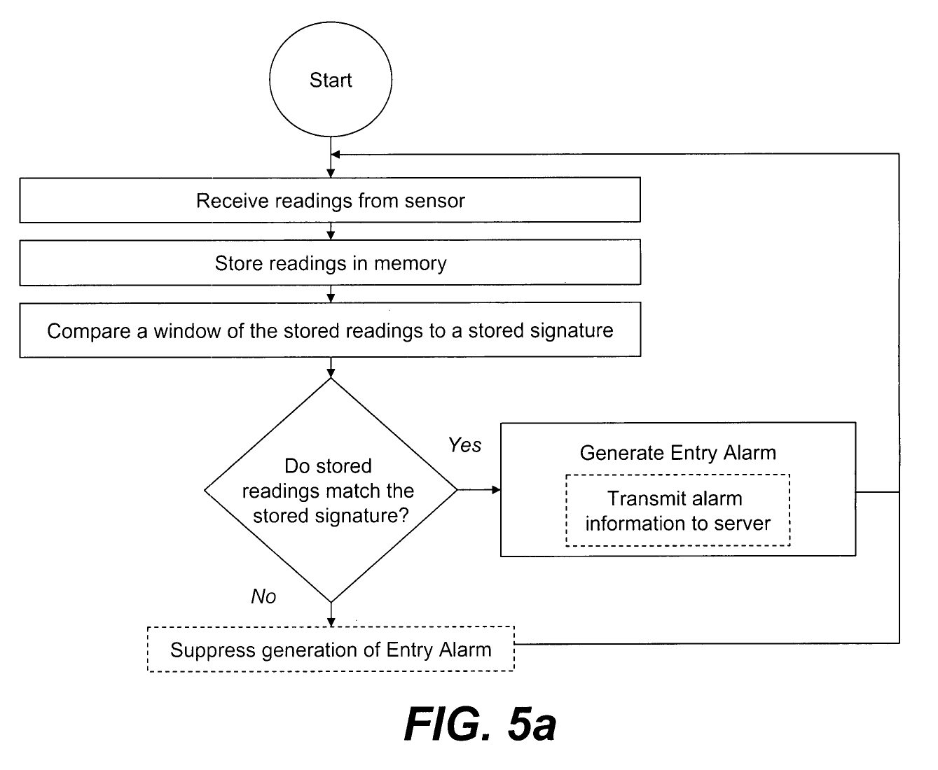

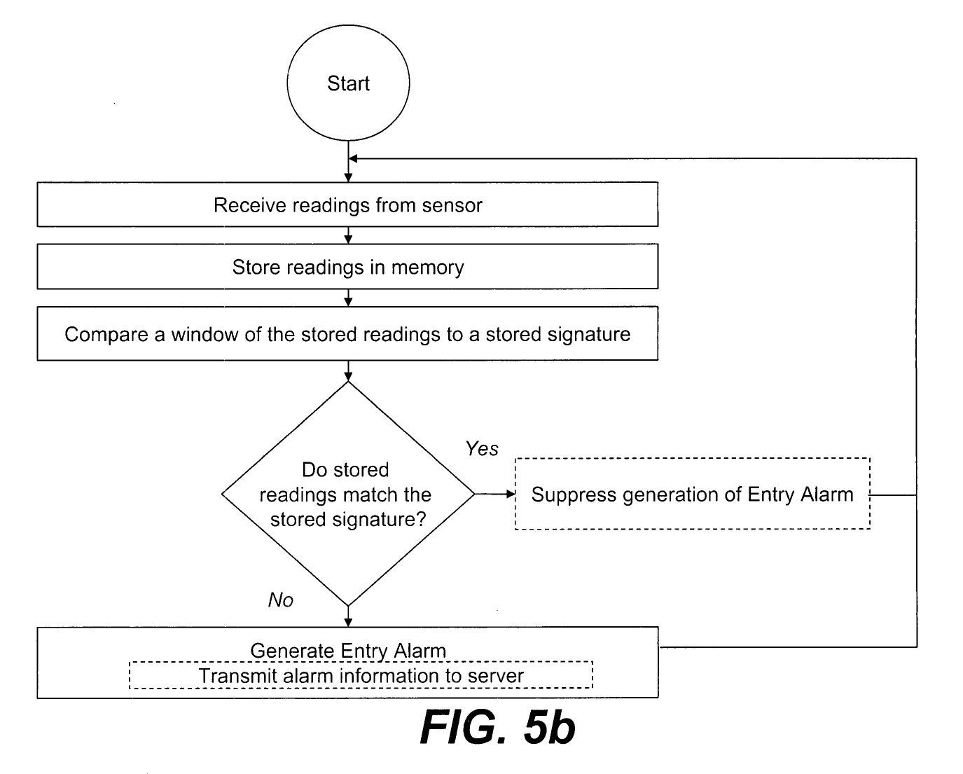

FIG. 5a charts a method for determining false alarms at an entry to an enclosure. A reading is received from a sensor, and temporarily stored in memory. This storage may occur digitally, that is, the stored signature, the stored reading, or both may be digitally stored, but storage may occur in other ways as well. A window of the stored reading, spanning a preselected period of time, may then be compared to a stored signature. This comparison may occur digitally, but analog comparison or other comparisons may alternatively occur. The stored signature represents a corresponding period of time and represents intrusion of the enclosure. An entry alarm is generated if the stored readings match the stored signature. This generating step may involve transmitting alarm information to a central server. An entry alarm is optionally suppressed if the stored readings do not match the stored signature.

FIG. 5b charts an alternative method, similar to the method of FIG. 5a, in which a window of the stored reading, spanning a preselected period of time, is compared to a stored signature which represents no intrusion of the enclosure, and an entry alarm is generated only if the stored readings do not match the stored signature.

The above methods may be applied to any kind of sensor, without limitation. As non-limiting examples, the sensor may be a tilt sensor, an acceleration sensor, a position sensor, a magnetic contact, a physical contact switch, an optical monitor, a ranging sensor, or a level sensor.

The above methods may be applied to a manhole, and where the sensor is an acceleration or tilt sensor attached to a cover of the manhole. The above methods may also be applied to a room, where the sensor is an acceleration sensor or contact switch attached to a door or window of the room. These are merely examples, however, and this method may be applied to any enclosure.

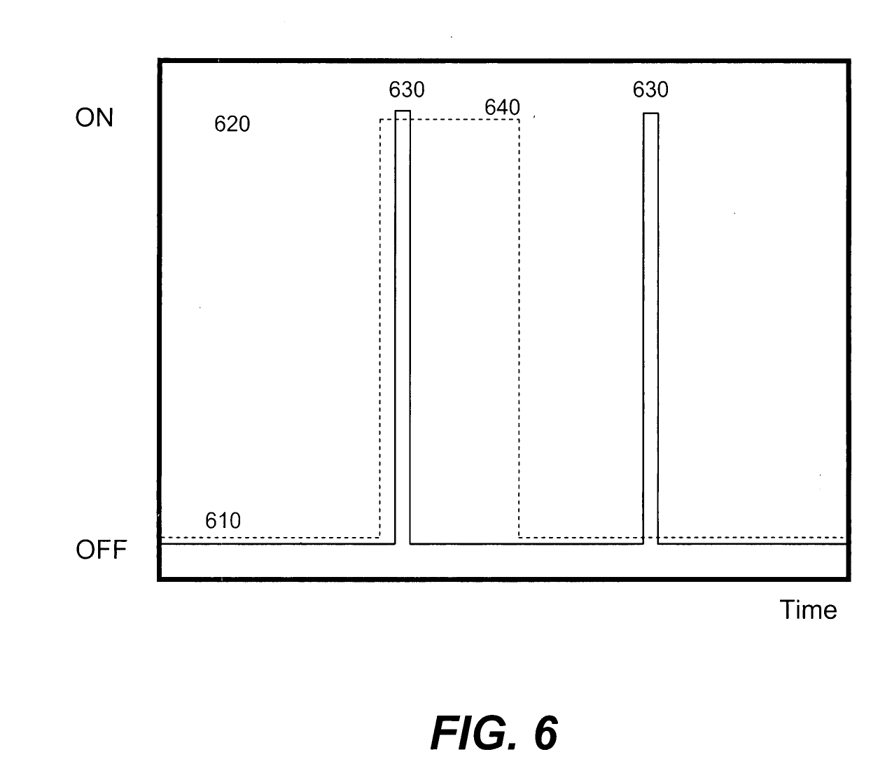

FIG. 6 shows a reading from a typical tilt sensor that is, for example, attached to a cover that is exposed to periodic shock, vibration or rotation generated by, for example, vehicular traffic travelling over the cover. Reading 630 shows the vehicular, non-entry signature of a continuous tilt sensor. The sensor has two states: “off” 610 and “on” 620. When a vehicle causes a cover to vibrate or rotate, this shock is of short duration and the sensor response is shown as an example as the curve 630. In accordance with the method described above in reference to FIG. 5a, since this curve 630 does not match the stored signature 640 in width (corresponding to time duration), it is presumed that the shock is a false alarm, and no alarm is generated.

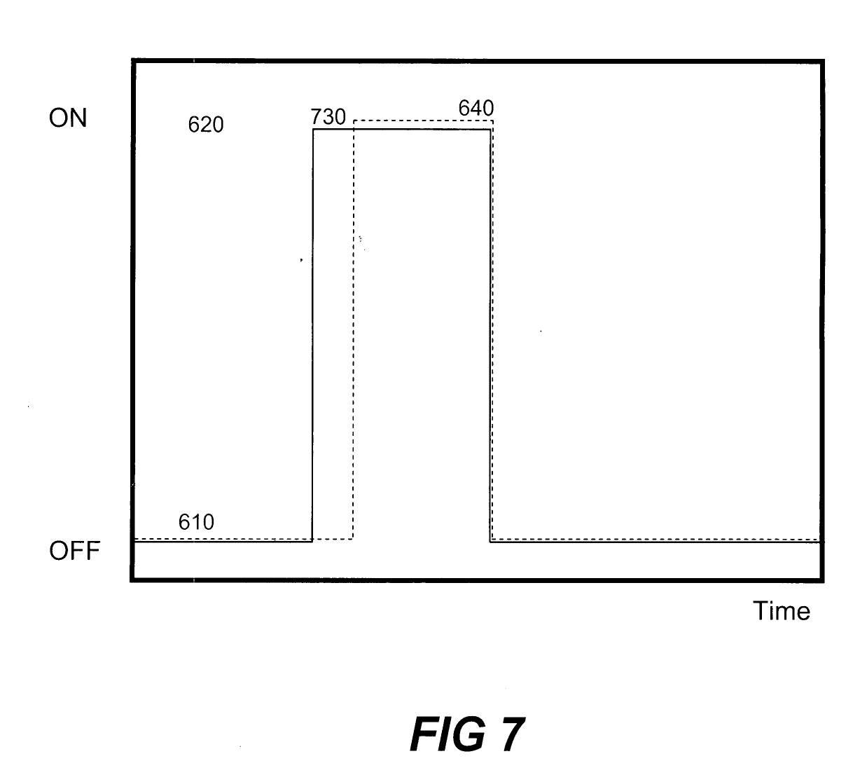

FIG. 7, alternatively, shows a reading from a tilt sensor corresponding to an actual opening of a cover, which has a distinctly different signature than that caused by a brief vehicular shock. Reading 730 shows the typical tilt sensor response for the case of a cover being opened, which is of much longer time duration that a short shock. Again, in accordance with the method described above in reference to FIG. 5a, since this reading corresponds sufficiently in time with the stored signature 640, an alarm is issued.

This is merely one example of comparison of signatures, and much more complex signature comparisons may be made. For example, the acceleration curve for an acceleration sensor may involve a particular shape corresponding to the lifting by a human of a heavy manhole cover, where an initial shock corresponds with the jarring loose of the cover, and low acceleration is associated with the subsequent placing aside of the cover. Such a shape may also be stored as a signature, and compared to a reading, to differentiate types of opening movement.

The present disclosure may be advantageously used with a number of systems for which the applicants have already filed for patent protection. Accordingly, the disclosure of U.S. patent application Ser. No. 11/641,110, filed Dec. 19, 2006, is hereby incorporated by reference in its entirety. Also, the disclosure of U.S. patent application Ser. No. 11/134,691, filed May 20, 2005 and granted on Nov. 6, 2007 as U.S. Pat. No. 7,292,143, is also hereby incorporated by reference in its entirety.

The previous description of some aspects is provided to enable any person skilled in the art to make or use the presently disclosed methods and apparatuses. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. Thus, the present invention is not intended to be limited to the aspects shown herein but is to be accorded the widest scope consistent with the principles and novel features disclosed herein.

What is claimed is:

1) A method for determining false alarms at an entry to an enclosure, the method comprising:
receiving a first reading from a first sensor, the first reading representing intrusion of the enclosure;
receiving a second reading from a second sensor; and
generating an entry alarm if the second reading confirms intrusion of the enclosure.

2) The method of claim 1, the method further comprising:
suppressing generation of the entry alarm if the second reading does not confirm intrusion of the enclosure.

3) The method of claim 1, the method further comprising:
receiving multiple readings from a plurality of sensors, and combining the multiple readings to produce the first reading or the second reading.

4) The method of claim 1, the method further comprising:
providing the first sensor or the second sensor with a tolerance such that the corresponding reading is provided only when the tolerance is exceeded.

5) The method of claim 1, wherein the generating step comprises transmitting alarm information to a central server.

6) An apparatus that determines false alarms at an entry to an enclosure, the apparatus comprising:
a first sensor which senses for intrusion of the enclosure and which generates a first reading;
a second sensor which generates a second reading; and
a processor comprising instructions for generating an alarm if the first reading represents intrusion of the enclosure and the second reading confirms intrusion of the enclosure.

7) The apparatus of claim 6, wherein the first sensor is a tilt sensor attached to a cover of the enclosure, and the first reading corresponds to tilting of the cover.

8) The apparatus of claim 6, wherein first sensor is an acceleration sensor attached to a cover of the enclosure, and the first reading corresponds to acceleration of the cover.

9) The apparatus of claim 6, wherein the second sensor is a ranging sensor attached to a cover of the enclosure, and the second reading corresponds to a distance from an opposing boundary of the enclosure.

10) The apparatus of claim 9, wherein the second sensor is an ultrasonic or laser ranger.

11) The apparatus of claim 6,
wherein the first sensor is selected from the group consisting of: tilt sensor, acceleration sensor, position sensor, magnetic contact, physical contact switch, optical monitor, ranging sensor, level sensor; and
wherein the second sensor is selected from the group consisting of: tilt sensor, acceleration sensor, position sensor, magnetic contact, physical contact switch, optical monitor, ranging sensor, level sensor.

12) The apparatus of claim 6, the apparatus further comprising:
a two-way communication module connected to the processor for communicating the alarms.

13) The apparatus of claim 6, wherein the enclosure is a manhole, and at least one of the first sensor and the second sensor is attached to a cover of the manhole.

14) The apparatus of claim 6, wherein the enclosure is a room, and at least one of the first sensor and the second sensor is attached to a door or window of the room.

15) A method for determining false alarms at an entry to an enclosure, the method comprising:
receiving readings from a sensor over a period of time;
storing the readings at least temporarily in a memory;
comparing a window of the stored readings to a stored signature, the window spanning a preselected period of time, the stored signature representing a corresponding period of time; and
(a) generating an entry alarm if the stored signature represents intrusion of the enclosure and if the stored readings match the stored signature, or
(b) generating an entry alarm if the stored signature represents no intrusion of the enclosure and if the stored readings do not match the stored signature.

16) The method of claim 15, wherein the sensor is selected from the group consisting of: tilt sensor, acceleration sensor, position sensor, magnetic contact, physical contact switch, optical monitor, ranging sensor, and level sensor.

17) The method of claim 15, wherein the stored signature is digitally stored and the stored reading is digitally stored, and the stored reading is digitally compared to the stored signature.

18) The method of claim 15, wherein the generating step comprises transmitting alarm information to a central server.

19) The method of claim 15, wherein the enclosure is a manhole, and the sensor is an acceleration or tilt sensor attached to a cover of the manhole.

20) The method of claim 15, wherein the enclosure is a room, and the sensor is an acceleration sensor or contact switch attached to a door or window of the room.
